(19) United States
(12) Patent Application Publication
(10) Pub. No.: US 2013/0156458 A1
(43) Pub. Date: Jun. 20, 2013

(54) DECOLORIZING APPARATUS

(71) Applicant: Katsunori Suzuki, Shizuoka-ken (JP)

(72) Inventor: Katsunori Suzuki, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/667,461

(22) Filed: Nov. 2, 2012

Related U.S. Application Data
(60) Provisional application No. 61/570,935, filed on Dec. 15, 2011.

(51) Int. Cl. G03G 15/00; G03G 15/20

(52) U.S. Cl. 399/81; 399/341

(57) ABSTRACT

According to one embodiment, a decolorizing apparatus includes a control section and a decolorizing section. The control section acquires information that distinguishes a first area, which is an area where an image is formed on a sheet, and the other areas. The decolorizing section decolorizes an image in the first area according to the information acquired by the control section.

### CROSS-REFERENCE TO RELATED APPLICATIONS

This application is based upon and claims the benefit of priority from: U.S. provisional application 61/570935, filed on Dec. 15, 2011; the entire contents all of which are incorporated herein by reference.

### FIELD

Embodiments described herein relate generally to a technique for controlling a decolorizing place by a decolorizing apparatus.

### BACKGROUND

There is a decolorizing apparatus that applies heat treatment or the like to a sheet printed with a decolorable toner, ink, or the like to erase a formed image. The sheet from which the image is erased can be reused.

There is a limit in the number of times images of a print are erased. Therefore, there is also an apparatus that identifies a printed sheet to thereby count the number of times of printing the sheet and determine whether the sheet can be reused. The apparatus conveys a sheet determined as un-reusable to a discard tray or a shredder and conveys a sheet determined as reusable to a predetermined tray.

However, the apparatus in the past that erases an image of a print by heating heats the entire sheet. Therefore, if a sheet printed only in a part is heated, an unprinted margin is also heated. Therefore, consumed energy increases.

### BRIEF DESCRIPTION OF THE DRAWINGS

FIG. 1 is a diagram of a configuration example of a decolorizing apparatus;

FIG. 2 is a flowchart for explaining an operation example of the decolorizing apparatus;

FIG. 3A is a diagram of an example of an original image displayed in a printing preview;

FIG. 3B is a diagram of an example in which a user designates a decolorizing area using squares;

FIG. 4A is a diagram of an example in which the user designates an upper half of a sheet as a decolorizing area;

FIG. 4B is a diagram of an example in which the user designates a left half of a sheet as a decolorizing area;

FIG. 5A is a diagram of an example in which the user designates a decolorizing area freehand;

FIG. 5B is a diagram of an example in which the user scans an un-decolorized sheet to specify an area and sets the area as a decolorizing area;

FIG. 6A is a diagram of an example of an original image having a QR code;

FIG. 6B is a diagram of an example in which the user reads the QR code and specifies a decolorizing area according to a read value;

FIG. 7 is a diagram for explaining that ON and OFF are controlled for each of regions of a decolorizing section; and

FIG. 8 is a diagram for explaining that the decolorizing section comes close to and separates from a sheet.

### DETAILED DESCRIPTION

In general, according to one embodiment, a decolorizing apparatus includes a control section and a decolorizing section. The control section acquires information that distinguishes a first area, which is an area where an image is formed on a sheet, and the other areas. The decolorizing section decolorizes an image in the first area according to the information acquired by the control section.

The decolorizing apparatus according to the embodiment heats and decolorizes toner on a sheet surface and erases an image formed on the sheet surface. Before the erasing, the decolorizing apparatus scans the sheet surface and displays a preview image on a control panel. A user refers to the preview display and designates an area of the sheet surface where the image is erased.

A method for the designation includes designating an area using squares or freehand and designating an area determined in advance (an upper half, a lower half, a right half, a left half, or the like of a sheet).

The decolorizing section sets the designated area as a decolorizing target and heats the sheet. Consequently, it is unnecessary to use excess heat unlike the method of heating the entire sheet.

The decolorizing apparatus according to the embodiment scans a print before erasing a toner image to detect in which position (area) the toner image is present. The decolorizing apparatus sets the detected area as a decolorizing target and heats the sheet. With this method, as in the method explained above, it is unnecessary to use excess heat.

The decolorizing apparatus according to the embodiment scans a sheet before erasing an image and reads a two-dimensional barcode (a QR code) formed on the sheet beforehand. In the two-dimensional barcode, position information indicating in which position (area) on the sheet the image is formed is encoded in a machine-readable format. When an image forming apparatus forms an image on a sheet with toner decolorized at fixed temperature, the two-dimensional barcode is formed in a margin simultaneously with the formation of the image. The decolorizing apparatus according to the embodiment sets, as a decolorizing target, an area indicated by a read value of the two-dimensional barcode and heats and decolorizes the sheet. With this method, as in the methods explained above, it is unnecessary to use excess heat.

An embodiment is explained below with reference to the accompanying drawings.

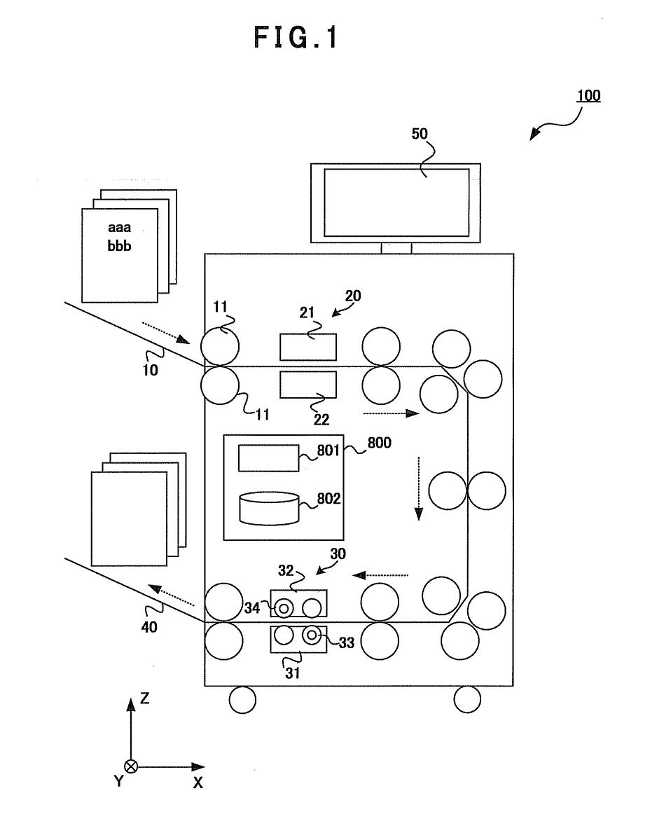

FIG. 1 is a schematic diagram of the configuration of a decolorizing apparatus according to an embodiment. A decolorizing target sheet placed on a supply tray 10 is conveyed to the inside of a main body of a decolorizing apparatus 100 by a pair of pickup rollers 11. The sheet conveyed to the inside of the main body is conveyed as indicated by broken line arrows. Both surfaces of the sheet are read by a reading section 20. Read image data is stored in a storing section 802 of a control board 800. The reading section 20 includes a scan unit 21 configured to read the upper surface of the conveyed sheet and a scan unit 22 configured to read the lower surface of the conveyed sheet. The sheet passes between the scan unit 21 and the scan unit 22. The scan units 21 and 22 respectively include image pickup devices such as CCD (Charge Coupled Device) image sensors.

The image data stored in the storing section 802 is preview-displayed on a control panel 50. The control panel 50 includes an input section of a touch panel type and a display section, which is a display of a flat type. The control panel 50 detects a touch of a fingertip or the like of a user and outputs the position of the touch to a processor 801 of the control board 800. The user touches the preview-displayed image on the input section to designate an area of a decolorizing target sheet to be decolorized. Position information of the designated area is stored in the storing section 802. Details of this operation are explained below.

After the images formed on the sheet surfaces are read by the reading section 20, the sheet is conveyed to a decolorizing section 30 by a plurality of rollers. The decolorizing section 30 applies heating treatment to the sheet to erase the images formed on the sheet. The decolorizing section 30 includes decolorizing units 31 and 32. The decolorizing units 31 and 32 respectively include heat generating bodies of heater rollers 33 and 34. The sheet passes between the decolorizing units 31 and 32 and comes into contact with the heater rollers 33 and 34 to be heated.

The sheet after the heating treatment is discharged to the outside of the decolorizing apparatus 100 and stacked on a tray 40.

The decolorizing apparatus 100 includes the control board 800. The control board 800 is a unit that collectively controls hardware in the decolorizing apparatus 100. The control board 800 includes the processor 801 and the storing section 802. The processor 801 is, for example, a CPU (Central Processing Unit) or an MPU (Micro Processing Unit). The processor 801 executes an arithmetic operation of a computer program stored in the storing section 802 in advance to output control signals to the respective kinds of hardware in the decolorizing apparatus 100. The storing section 802 is a storing unit including a volatile main storage device (e.g., a RAM (Random Access Memory)) and a nonvolatile auxiliary storage device (e.g., a flash memory or a hard disk drive). The storing section 802 stores the computer programs, data used in processing, image data, and the like.

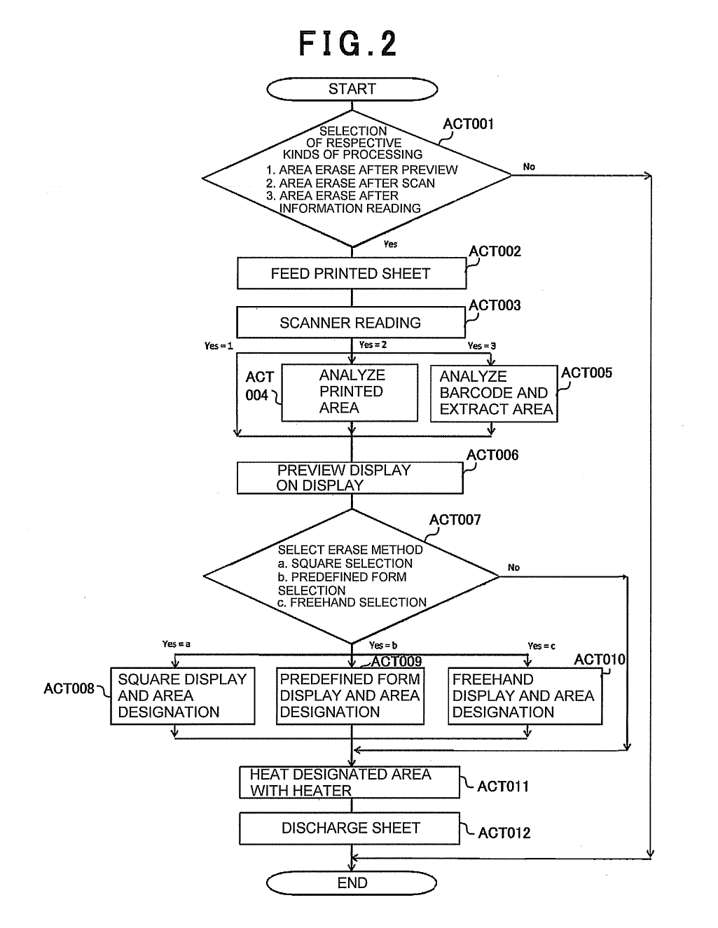

Designation and detection of a decolorizing target area are explained with reference to a flowchart of FIG. 2.

The control panel 50 displays a dialog for causing the user to select items explained below.

### 1. Area Erase After Preview

Displaying a preview image and causing the user to designate a decolorizing target area

### 2. Area Erase After Scan

Automatically extracting an area where an image is formed in image data after scan and setting the area as a decolorizing target area

### 3. Area Erase After Information Reading

Reading and analyzing a two-dimensional barcode to automatically extract an area where an image is formed and setting the area as a decolorizing target area

If the control panel 50 receives selection of the item from the user (Yes in ACT 001), a printed sheet (a sheet to be reused) stacked on the tray 10 is conveyed to the inside of the main body according to the rotation of the pickup rollers 11 (ACT 002). Both surfaces of the sheet conveyed to the inside of the main body are scanned by the reading section 20 (ACT 003).

If processing selected by the user is “1. Area erase after preview” (Yes=1), the processing proceeds to ACT 006.

If processing selected by the user is “2. Area erase after scan” (Yes=2), the control board 800 performs analysis of an area where a scan image stored in the storing section 802 is printed (ACT 004). The control board 800 compares pixel values of pixels in the scan image and a threshold defined beforehand to determine whether the pixels are a printed place. If the pixels determined as the printed place are grouped together, the control board 800 generates a rectangular area including the group and stores position information (in this example, a coordinate value starting from the upper left end of the scan image) in the storing section 802 with the area set as a decolorizing target area. Besides this example, there are various implementations of the specification of the decolorizing target area.

If processing selected by the user is “3. Area erase after information reading” (Yes=3), the control board 800 analyzes, with the technique in the past, a two-dimensional barcode formed in a predetermined position of the scan image and extracts information concerning a decolorizing target area (e.g., a coordinate value of the area) included in information in the two-dimensional barcode (ACT 005). The control board 800 stores the extracted information in the storing section 802 as the decolorizing target area.

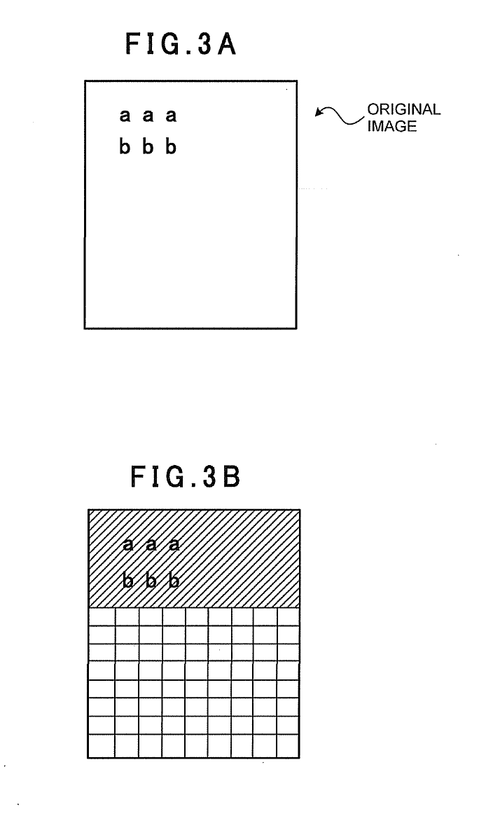

Thereafter, the control panel 50 preview-displays the scan image according to an instruction of the control board 800 (ACT 006). For example, an original image shown in FIG. 3A is displayed. At this point, the control panel 50 displays a dialog for causing the user to select a designation method for the decolorizing target area.

If the user selects “square selection” (ACT 007, Yes=a), the control panel 50 superimposes a plurality of longitudinal and lateral lines on the preview image to form squares and displays a touch position of the fingertip of the user in gray in a square unit (ACT 008). FIG. 3B is a diagram of a display example at this point. Position information of a square designated by the user (information concerning the position of the squire on the longitudinal and lateral lines) is converted into a coordinate value and stored in the storing section 802.

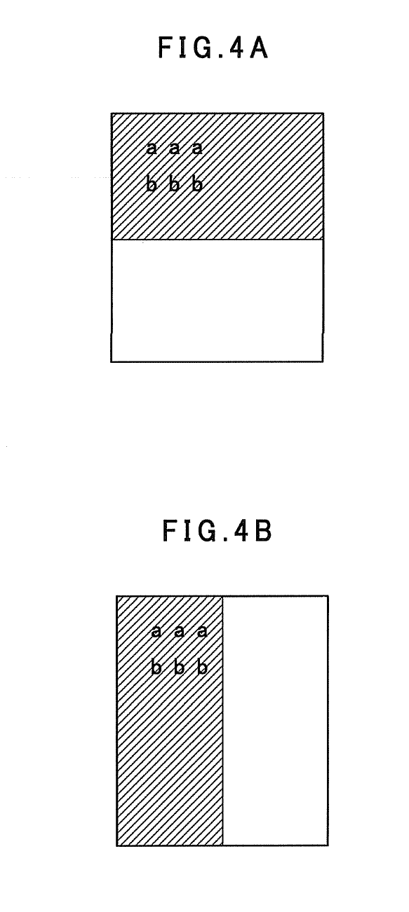

If the user selects “predefined form selection” (ACT 0007, Yes=b), the control panel 50 further displays a dialog for causing the user to select an area defined beforehand (an upper half, a lower half, a right half, a left half, or the like of the sheet) and displays a form corresponding to the selection while superimposing the form on the preview image (ACT 009). FIG. 4A is a display example in which the sheet upper half is selected. FIG. 4B is a display example in which the sheet left half is selected. If the form is decided, coordinate information of a region displayed in gray is stored in the storing section 802.

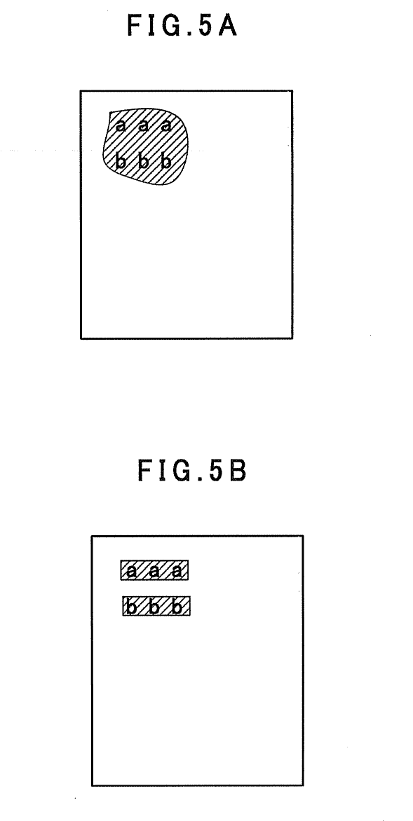

If the user selects “freehand selection” (ACT 007, Yes=c), the control panel 50 acquires a coordinate of the contact with the fingertip of the user and displays a track of the coordinate according to an instruction of the control board 800 (ACT 010). The control board 800 connects a start point and an end point of the track to generate a closed region. The control panel 50 displays the closed region. FIG. 5A is a diagram of a display example in which an area is designated freehand. If the area is decided, coordinate information of the region displayed in gray is stored in the storing section 802.

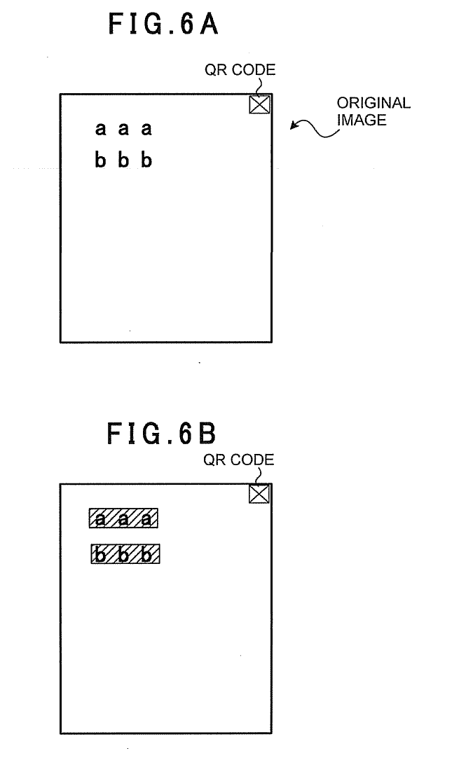

FIG. 5B is a diagram of a display example in ACT 006 in which the area is extracted in ACT 004. FIGS. 6A and 6B are diagrams for explaining the processing in ACT 005. FIG. 6A is a diagram of an example of the position of a two-dimensional barcode (a QR code) formed on the original image. FIG. 6B is a diagram of a display example in ACT 006 corresponding to an extraction result of the position. Concerning an automatically-generated area shown in FIGS. 5B, 6A, and 6B, the user can correct, add, or delete the area by himself or herself in ACT 007 to ACT 010. If an area is automatically designated by the scan or the two-dimensional barcode, it is possible to adopt an implementation for performing only preview display and not receiving correction by the user (the processing shifts to ACT 011 after ACT 006) or an implementation for not performing even the preview display (the processing shifts to ACT 011 after ACT 004 and ACT 005). When the preview display is performed, it is necessary to temporarily stop the conveyance of the sheet and put the sheet on standby. In this embodiment, as shown in FIG. 1, since the sheet is put on standby, a space equivalent to the sheet length is secured between the reading section 20 and the decolorizing section 30. However, if the preview function is not used, the reading section 20 and the decolorizing section 30 may be integrated.

The area designated by the user or the automatically-designated area is heated by the decolorizing section 30 (a heater) (ACT 011) and the sheet is discharged to the tray 40 (ACT 012).

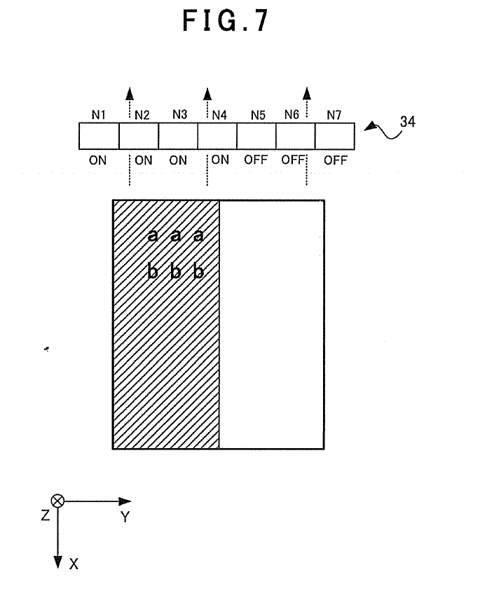

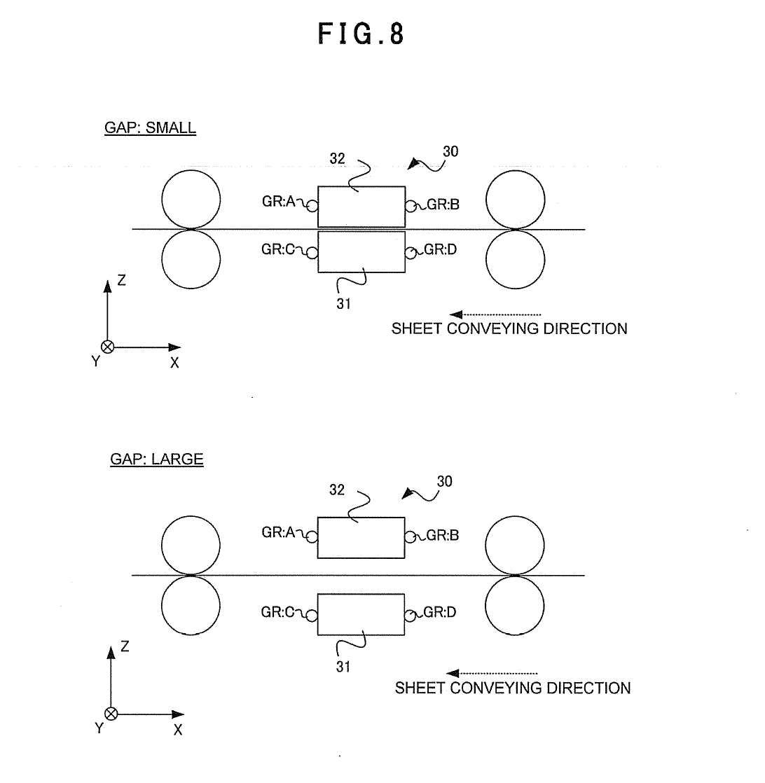

The control of the decolorizing section 30 in ACT 011 is explained below with reference to FIGS. 7 and 8. FIG. 7 is a diagram for explaining that the sheet left half is set as a decolorizing target and is a schematic diagram of the heater roller 34 of the decolorizing unit 32 viewed from the upper surface of the sheet. Broken line arrows in FIG. 7 indicate a conveying direction of the sheet. The heater roller 34 of the decolorizing unit 32 is divided into N1 to N7 in a direction perpendicular to a sheet conveying direction. N1 to N7 are individually controlled. The control board 800 can apply control of ON and OFF to each of N1 to N7 of the heater roller 34. If the user designates the sheet left half, the control board 800 can erase an image in the sheet left half by turning on N1 to N4 of the heater roller 34 and heating only N1 to N4. The control board 800 turns off N5 to N7 of the heater roller 34 and does not heat N5 to N7. Therefore, excess energy is not output. According to such control, an unnecessary area is not heated. It is possible to suppress deterioration of the sheet due to heat. The same applies to the heater roller 33 of the decolorizing unit 31.

FIG. 8 is an enlarged diagram of the decolorizing section and is a schematic diagram for explaining that the decolorizing units 31 and 32 come close to and separate from the sheet. The upper figure of FIG. 8 shows a state in which the decolorizing units 31 and 32 are close to the sheet (a gap is small) and the lower figure of FIG. 8 shows a state in which the decolorizing units 31 and 32 are separated from the sheet (a gap is large). It is possible to efficiently heat the sheet and erase a toner image by, according to the control by the control board 800, narrowing the gap between the vertically-set decolorizing units 31 and 32 and bringing the heater rollers 33 and 34 into contact with the sheet.

Gap adjustment is performed by gap adjusting rollers (GR:A, GR:B, GR:C, and GR:D). If the gap adjusting roller GR:A rotates to the right (clockwise on the drawing) and the gap adjusting roller GR:B rotates to the left, the upper decolorizing unit 32 moves in the downward direction to narrow the gap. If the gap adjusting roller GR:C rotates to the left and the gap adjusting roller GR:D rotates to the right, the lower decolorizing unit 31 moves in the upward direction to narrow the gap.

Conversely, if the gap adjusting roller GR:A rotates to the left and the gap adjusting roller GR:B rotates to the right, the upper decolorizing unit 32 moves in the upward direction to widen the gap. If the gap adjusting roller GR:C rotates to the right and the gap adjusting roller GR:D rotates to the left, the lower decolorizing unit 31 moves in the downward direction to widen the gap.

According to the use of the mechanism shown in FIG. 8, if the user designates the sheet upper half in “predefined form designation” after preview (see FIG. 4A), when the upper half of the sheet passes the decolorizing section 30, the control board 800 narrows the gap and heats the area of the designated upper half to erase an image. When the lower half of the sheet passes the decolorizing section 30, the control board 800 widens the gap and conveys the sheet without heating the lower half not designated by the user. The control board 800 turns on or off the heater rollers 33 and 34 according to the narrowing or the widening of the gap. In other words, if the gap is narrowed, power supply to the heater rollers 33 and 34 is turned on. If the gap is widened, power supply to the heater rollers 33 and 34 is turned off.

The control board 800 can adopt areas having various shapes as the decolorizing target area by combining the mechanism explained with reference to FIG. 7 and the mechanism explained with reference to FIG. 8 to perform control. Since the area not designated by the user is not heated, excess energy is not output. Since the unnecessary area is not heated, deterioration of the sheet due to heat is suppressed and durability of the sheet increases.

In the example explained above, the implementation example for designating the decolorizing target area is explained. However, an implementation for designating an area not set as a decolorizing target may be adopted. In this case, area other than a designated area is decolorized.

In the example explained above, the implementation example for distinguishing the decolorizing target area (a first area) and the other areas is explained. As an example, the implementation example is explained in which the user designates the decolorizing target area or the decolorizing target area is automatically designated. In the example explained above, position information of the decolorizing target area is stored in the storing section 802 and position information of the area not set as a decolorizing target is not stored in the storing section 802 to distinguish the decolorizing target area and the area not set as a decolorizing target. Besides this example, it is possible to adopt, for example, an implementation for creating 1-bit raster data corresponding to a pixel of a document image, setting a bit value of the decolorizing target area to 1, and setting a bit value of the area not set as a decolorizing target to 0 to distinguish the decolorizing target area and the area not set as a decolorizing target. Further, various other implementations are conceivable.

In the explanation of the example, the area is mainly a rectangular region and is a relatively large area. As the rectangular region, it is also possible to designate a finer area by increasing the number of divisions of the heater roller 34 shown in FIG. 7 (in the example shown in FIG. 7, the heater roller 34 is divided into seven, i.e., N1 to N7) and closely controlling the mechanism shown in FIG. 8.

As explained above in detail, according to the technique described in this specification, it is possible to heat a part of a sheet rather than heating the entire surface of the sheet. Therefore, it is possible to suppress energy consumption and suppress deterioration of the sheet due to heat.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. A decolorizing apparatus comprising:
a control section configured to acquire information that distinguishes a first area, which is an area where an image is formed on a sheet, and other areas; and
a decolorizing section configured to decolorize an image in the first area according to the information acquired by the control section.

2. The apparatus according to claim 1, further comprising an input section configured to receive designation of an area from a user, wherein
the control section sets, as a first area, the user-designated area obtained by the input section.

3. The apparatus according to claim 2, wherein the control section sets, as the first area, an area designated by the user using the input section among a plurality of areas defined beforehand.

4. The apparatus according to claim 2, further comprising;
a reading section configured to scan the sheet before processing by the decolorizing section; and
a display section configured to preview-display an image scanned by the reading section and display an image indicating the area designated by the user using the input section while superimposing the image on the preview-displayed image.

5. The apparatus according to claim 4, wherein
the display section displays longitudinal and lateral lines while superimposing the longitudinal and lateral lines on the preview-displayed image, and
the input section receives, with a square formed by the longitudinal and lateral lines set as a unit of designation, designation of an area from the user.

6. The apparatus according to claim 3, wherein the input section receives, as the area designated by the user, an area formed by the user freehand.

7. The apparatus according to claim 1, further comprising a reading section configured to scan the sheet before processing by the decolorizing section, wherein
the control section specifies an area where an image is formed in the sheet scanned by the reading section and sets the area as the first area.

8. The apparatus according to claim 1, further comprising a reading section configured to scan the sheet before processing by the decolorizing section, wherein
the control section acquires, from a code formed in the sheet scanned by the reading section, information indicating in which place of the sheet an image is formed and set an area indicated by the information as a first area.

9. The apparatus according to claim 1, wherein the decolorizing section is divided into sections in a direction perpendicular to a sheet conveying direction, the decolorizing section including, in each of the divided sections, a heat generating body controlled to generate heat.

10. The apparatus according to claim 1, wherein the decolorizing section comes into contact with or separates from the sheet conveyed thereto to decolorize the image in the first area.
